(19) United States
(12) Patent Application Publication
(10) Pub. No.: US 2015/0348115 A1
(43) Pub. Date: Dec. 3, 2015

(54) CONTENT OUTPUT APPARATUS, CONTENT OUTPUT METHOD, COMMUNICATION TERMINAL, AND COMPUTER-READABLE MEDIUM

(71) Applicant: CASIO COMPUTER CO., LTD., Tokyo (JP)

(72) Inventors: Toshihiko YOSHIDA, Tokyo (JP); Takashi KAWASHIMO, Tokyo (JP); Gou KAWAKAMI, Tokyo (JP); Asami ASO, Tokyo (JP); Yoshinari MIYAZAKI, Ageo-shi (JP)

(73) Assignee: CASIO COMPUTER CO., LTD., Tokyo (JP)

(21) Appl. No.: 14/715,085

(22) Filed: May 18, 2015

(30) Foreign Application Priority Data
Jun. 3, 2014 (JP) 2014-114467

(51) Int. Cl. G06Q 30/02; H04W 24/08; H04M 1/02

(52) U.S. Cl. CPC G06Q 30/0267; H04M 1/0202; H04W 24/08

(57) ABSTRACT

A content output system for outputting content to digital signage makes customers continuously feel interactivity with content to maintain their interest. A content output system 1 includes: an NFC communication unit 31 that wirelessly communicates with a communication terminal 2; a communication number count unit 32 that counts the number of communications with the communication terminal 2 on a predetermined period basis; a content selection unit 33 that selects content corresponding to the number of communications counted by the communication number count unit 32; and a content output unit 34 that displays the content selected by the content selection unit 33 on a screen.

### BACKGROUND OF THE INVENTION

1. Field of the Invention

The present invention relates to a content output apparatus, a content output method, a communication terminal, and a computer-readable medium.

2. Background Art

With the development of digital imaging technologies in recent years, digital signage is gaining attention. The number of digital signage installations is increasing in stores, public transportation systems, public facilities, corporate establishments, and so on.

As one implementation form of digital signage, a technique called virtual mannequin is known. A virtual mannequin is, for example, video content of a human or a character projected onto a life-sized screen shaped like a human. This realizes life-sized point of purchase (POP) advertising that moves and talks, which is expected to have a high eye catching effect. Virtual mannequins are therefore suitable for use in stores and amusement facilities.

An example of virtual mannequin techniques is described in Patent Document 1. The problem stated in Patent Document 1 is: “to provide video output apparatus mounting equipment and a projection method of a video output apparatus that can enhance viewers' impressions”. The solution stated in Patent Document 1 is: “video output apparatus mounting equipment in which a video output apparatus connected with a video supply apparatus is mounted, wherein output light for projecting content from the video output apparatus is reflected by a reflection member provided in the video output apparatus mounting equipment, and the output light reflected by the reflection member is projected onto a screen shaped in the outline of the content”.

The number of stores introducing loyalty programs to attract customers is also on the increase in recent years. A loyalty program is a service that offers predetermined points to customers depending on, for example, the amount purchased or the number of visits. Customers can use their points for part of purchases or exchange the points into goods.

[Patent Document 1] Japanese Patent Application Laid-Open No. 2011-150221

### SUMMARY OF THE INVENTION

The video supply apparatus described in Patent Document 1 detects a person present within a predetermined range by a motion detector, and causes the video output apparatus to project content onto the screen. The playback of the content is thus started at the timing of someone approaching. This is expected to have a high eye catching effect, as customers can initially feel interactivity with content.

However, the video supply apparatus described in Patent Document 1 merely determines whether or not someone is approaching, which is one-sided. Accordingly, customers may gradually stop feeling interactivity with content and lose interest.

Methods for counting the number of visits in a loyalty program include a method of manual counting by store staff and a method of installing a special-purpose terminal for reading loyalty cards. However, the manual method is likely to require an enormous number of man-hours, and is impractical. The method using the special-purpose terminal is conditional on performing some kind of read operation such as each customer passing his or her loyalty card over or inserting the loyalty card into the special-purpose terminal. The customer may get tired of the operation of having the special-purpose terminal read the loyalty card and lose interest, and become less and less motivated to operate the special-purpose terminal.

In view of this, the present invention has an object of providing a content output apparatus, a content output method, a communication terminal, and a computer-readable medium that can make customers continuously feel interactivity with content to maintain their interest.

To achieve the stated object, the present invention is a content output apparatus including: a communication unit configured to wirelessly communicate with a communication terminal carried by a customer; a control unit configured to count the number of communications with the communication terminal on a predetermined period basis, and select content corresponding to the number of communications; and a content output unit configured to output the content selected by the control unit.

According to the present invention, it is possible to make customers continuously feel interactivity with content.

### BRIEF DESCRIPTION OF THE DRAWINGS

FIG. 1 is a block diagram schematically illustrating a content output system in a first embodiment.

FIG. 2 is a perspective view of a content output unit in the first embodiment.

FIG. 3 is a flowchart illustrating a process by a content output apparatus in the first embodiment.

FIG. 4 is a block diagram schematically illustrating a content output system in a second embodiment.

FIG. 5 is a diagram illustrating a communication management database in the second embodiment.

FIG. 6 is a flowchart illustrating a process by a content output apparatus in the second embodiment.

FIG. 7 is a flowchart illustrating a process by a server in the second embodiment.

FIG. 8 is a block diagram schematically illustrating a content output system in a third embodiment.

FIG. 9 is a diagram illustrating a communication log database in the third embodiment.

FIG. 10 is a flowchart illustrating a process by a content output apparatus in the third embodiment.

FIG. 11 is a flowchart illustrating a process by a server in the third embodiment.

### DESCRIPTION OF THE PREFERRED EMBODIMENTS

The following describes embodiments of the present invention in detail, with reference to drawings.

### First Embodiment

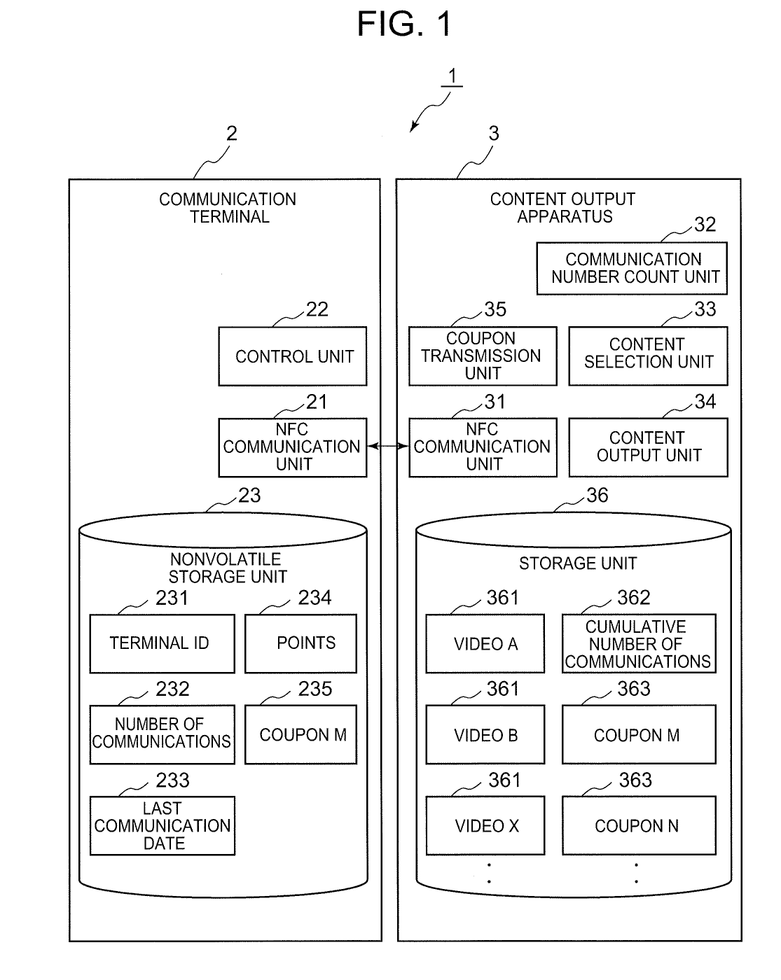

FIG. 1 is a block diagram schematically illustrating a content output system 1 in a first embodiment.

As illustrated in FIG. 1, the content output system 1 includes a communication terminal 2 having a communication function of the near field communication (NFC) standard, and a content output apparatus 3 capable of wirelessly communicating with the communication terminal 2. The content output apparatus 3 is installed in, for example, a store, a public facility, or a corporate establishment to attract customers.

The communication terminal 2 is a mobile terminal of each customer, such as a smartphone, a mobile phone terminal, or a tablet terminal. The communication terminal 2 includes an NFC communication unit 21 that realizes the communication function of the NFC standard, a control unit 22 that controls the communication terminal 2, and a nonvolatile storage unit 23 such as flash memory.

By passing the communication terminal 2 over the content output apparatus 3, each customer can make the content output apparatus 3 create a virtual mannequin, and also receive points and a coupon.

The NFC communication unit 21 transmits and receives information of the number of communications and the last communication date to and from the content output apparatus 3.

The control unit 22 is realized by a central processing unit (CPU) (not illustrated) executing an application program in, for example, a smartphone.

The nonvolatile storage unit 23 stores terminal ID information 231 for identifying the terminal, communication number information 232, last communication date information 233, point information 234, and coupon information 235.

The terminal ID information 231 is identification information for distinguishing the communication terminal 2 from other communication terminals 2. The communication number information 232 is the number of communications performed by the communication terminal 2 with the content output apparatus 3 on a daily basis. The last communication date information 233 is information of the last date of communication performed by the communication terminal 2 with the content output apparatus 3.

The point information 234 is information of points provided from the content output apparatus 3 to the communication terminal 2. The customer having the communication terminal 2 can use the point information 234 for part of purchases in the store or exchange the point information 234 into goods.

The coupon information 235 is information of coupons provided from the content output apparatus 3 to the communication terminal 2. An example of the coupon information 235 is an image file indicating a target piece of goods or a target service and a benefit of purchasing the target piece of goods or service. The coupon information 235 is information to be distributed to customers. The customer having the communication terminal 2 can receive the benefit of purchasing the piece of goods or service, by displaying the coupon information 235 on the liquid crystal display unit or the like of the communication terminal 2 and showing the display to the store staff. In FIG. 1, a coupon M is stored in the nonvolatile storage unit 23 in the communication terminal 2.

The content output apparatus 3 includes an NFC communication unit 31, a communication number count unit 32, a content selection unit 33, a content output unit 34, a coupon transmission unit 35, and a storage unit 36. The content output apparatus 3 outputs content to digital signage such as a virtual mannequin.

The storage unit 36 is, for example, a hard disk, flash memory, or random access memory (RAM). The storage unit 36 stores each set of video content information 361, cumulative communication number information 362, and each set of coupon information 363.

The video content information 361 is information of video content of a human or a character to be projected onto a human-shaped life-sized display. These sets of video content information 361 include audio streams. Of the video content information 361, video content A is content displayed by default, video content B is content displayed when the number of communications has reached 5, and video content X is content displayed when the cumulative number of communications has reached 1000000.

The cumulative communication number information 362 is the cumulative number of communications with communication terminals 2. The number of communications with each communication terminal 2 is counted on a daily basis. The cumulative communication number information 362 indicates the cumulative number of customers who visited the store and passed their communication terminals 2 over the content output apparatus 3.

The coupon information 363 is information of coupons provided from the content output apparatus 3 to each communication terminal 2. Coupons M and N are stored in the storage unit 36 in FIG. 1.

The NFC communication unit 31 realizes the communication function of the NFC standard. The content output apparatus 3 is capable of wirelessly communicating with the communication terminal 2 by the NFC communication unit 31.

The communication number count unit 32 counts the number of communications with each communication terminal 2 on a daily basis. Even when a plurality of communications are performed with the same communication terminal 2 on the same day, the communication number count unit 32 counts the number of communications as 1. The communication number count unit 32 counts the number of communications on a daily basis, by comparing the date and time of communication by the NFC communication unit 31 with the last communication date and time. Even when the customer repeatedly passes over the communication terminal 2 over the content output apparatus 3 on the same day, the communication number count unit 32 counts the number of communications as 1. In so doing, the communication number count unit 32 can determine the number of visits by the customer from the number of communications.

The content selection unit 33 selects any of the video content A, B, and X, according to the number of communications or the cumulative number of communications counted by the communication number count unit 32. The content selection unit 33 thus outputs the content corresponding to the number of visits by each customer. This makes the customer continuously feel interactivity with content to maintain his or her interest.

The content output unit 34 projects the video content information 361 selected by the content selection unit 33 onto the human-shaped life-sized display, and outputs the corresponding audio stream to a speaker. The virtual mannequin is created in this way.

The coupon transmission unit 35 (customer distribution information transmission unit) transmits the coupon information 235 to the communication terminal 2 by the NFC communication unit 31. Note that the information distributed to the customer is not limited to a coupon, but may be any information useful for the customer. For example, the customer distribution information may be an image displayed on the communication terminal 2 as a wallpaper, audio content played when the communication terminal 2 receives a call or a message, or an image of the store's mascot character.

The content output apparatus 3 stores a content output program (not illustrated) in the storage unit 36. The content output apparatus 3 realizes the communication number count unit 32, the content selection unit 33, the content output unit 34, and the coupon transmission unit 35, by a CPU (not illustrated) executing the content output program.

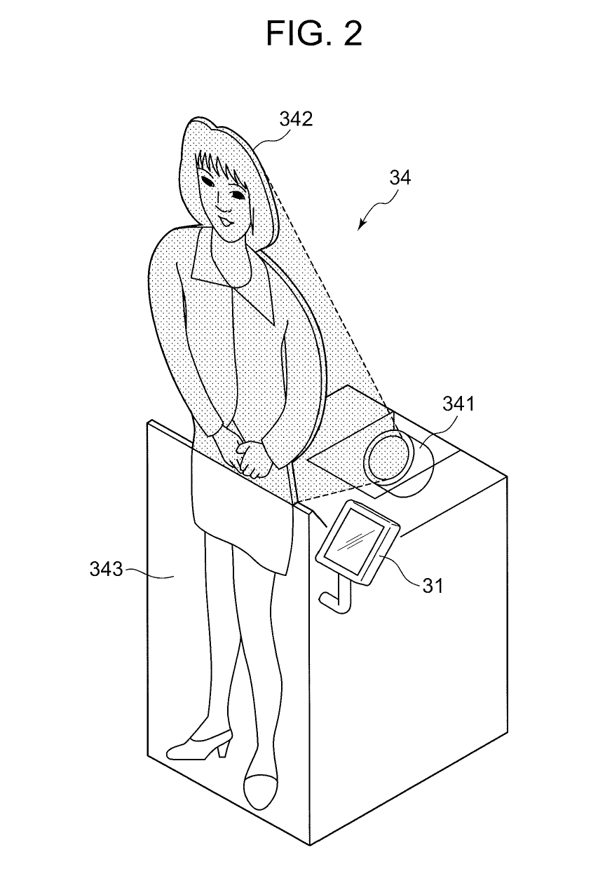

FIG. 2 is a perspective view of the content output unit 34 in the first embodiment.

As illustrated in FIG. 2, the content output unit 34 has a vertically-long rectangular parallelepiped housing. The content output unit 34 has a projector 341 located on the upper surface of the housing, a print unit 343 located on one side surface of the housing, a translucent screen 342 located above the print unit 343, the NFC communication unit 31 located on the right of the housing, and a speaker (not illustrated).

The translucent screen 342 is, for example, an acrylic plate or glass plate cut into the shape of the upper body of a human. The translucent screen 342 is combined with the print unit 343 on which the lower body of a human is printed, to constitute the human-shaped life-sized display.

The projector 341 projects the video content information 361 (see FIG. 1) onto the translucent screen 342. The speaker (not illustrated) outputs the audio stream of the video content information 361 (see FIG. 1). In each set of video content information 361, the area not projected onto the translucent screen 342 is set to black color so as not to cause glare to viewers (customers).

The NFC communication unit 31 is fixed to the right of the housing by a support member. When the customer passes the communication terminal 2 over the NFC communication unit 31, the video content is output to create the virtual mannequin.

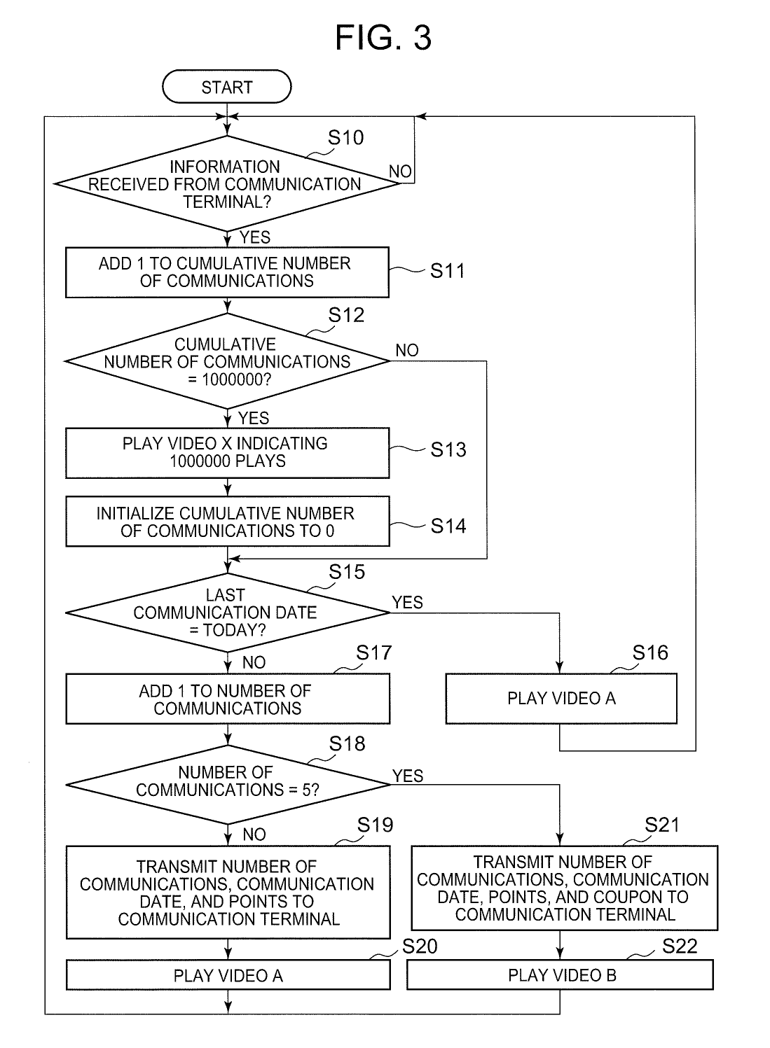

FIG. 3 is a flowchart illustrating the process by the content output apparatus 3 in the first embodiment.

When the content output apparatus 3 is activated, the content output apparatus 3 starts the process in FIG. 3.

In step S10, the NFC communication unit 31 in the content output apparatus 3 determines whether or not the terminal ID information 231 and the last communication date information 233 have been received from the communication terminal 2. In the case where the terminal ID information 231 and the last communication date information 233 have not been received (No), the content output apparatus 3 repeats the process in step S10. In the case where the terminal ID information 231 and the last communication date information 233 have been received (Yes), the content output apparatus 3 performs the process in step S11.

In step S11, the communication number count unit 32 in the content output apparatus 3 adds 1 to the cumulative number of communications. The cumulative number of communications mentioned here is the information included in the cumulative communication number information 362.

In step S12, the content selection unit 33 in the content output apparatus 3 determines whether or not the cumulative number of communications has reached 1000000. In the case where the cumulative number of communications has reached 1000000 (Yes), the content output apparatus 3 performs the process in step S13. In the case where the cumulative number of communications has not reached 1000000 (No), the content output apparatus 3 performs the process in step S15.

In step S13, the content selection unit 33 in the content output apparatus 3 selects the video content X, and the content output unit 34 outputs the video content X. The video content X is the content for celebrating 1000000 visits.

In step S14, the communication number count unit 32 in the content output apparatus 3 initializes the cumulative number of communications to 0.

By this operation, the content output apparatus 3 displays the video corresponding to the cumulative number of communications. As a result, customers who have not subscribed to the loyalty program can be made to become interested in the content output apparatus 3, and encouraged to subscribe to the loyalty program. Moreover, customers who have already subscribed to the loyalty program can be made to continuously feel interactivity with content, and maintain their interest in the virtual mannequin and the loyalty program.

In step S15, the communication number count unit 32 in the content output apparatus 3 determines whether or not the last date of communication with the communication terminal 2 is today, based on the last communication date information 233 of the communication terminal 2. In the case where the last communication date is today (Yes), the content output apparatus 3 performs the process in step S16. In the case where the last communication date is not today (No), the content output apparatus 3 performs the process in step S17.

Even when a plurality of communications are performed with the same communication terminal 2 on the same day, the communication number count unit 32 counts the number of communications as 1. The communication number count unit 32 can thus motivate the customer having the communication terminal 2 to visit the store again on a different day.

In step S16, the content selection unit 33 in the content output apparatus 3 selects the video content A, and the content output unit 34 outputs the video content A. After the process in step S16 ends, the content output apparatus 3 returns to the process in step S10.

In step S17, the communication number count unit 32 in the content output apparatus 3 adds 1 to the number of communications with the communication terminal 2.

In step S18, the content selection unit 33 in the content output apparatus 3 determines whether or not the number of communications with the communication terminal 2 is 5. In the case where the number of communications with the communication terminal 2 is 5 (Yes), the content output apparatus 3 performs the process in step S21. In the case where the number of communications with the communication terminal 2 is not 5 (No), the content output apparatus 3 performs the process in step S19.

In step S19, the content selection unit 33 in the content output apparatus 3 has the NFC communication unit 31 transmit the number of communications, the communication date, and a predetermined number of points to the communication terminal 2. The communication terminal 2 stores the transmitted number of communications, communication date, and predetermined number of points in the nonvolatile storage unit 23.

In step S20, the content selection unit 33 in the content output apparatus 3 selects the default video content A, and the content output unit 34 outputs the video content A. After the process in step S20 ends, the content output apparatus 3 returns to the process in step S10.

In step S21, the NFC communication unit 31 in the content output apparatus 3 transmits the number of communications, the communication date, a predetermined number of points, and a coupon to the communication terminal 2. The communication terminal 2 stores the transmitted number of communications, communication date, predetermined number of points, and coupon in the nonvolatile storage unit 23.

In step S22, the content selection unit 33 in the content output apparatus 3 selects the video content B for customers who have repeatedly visited the store, and the content output unit 34 outputs the video content B. After the process in step S22 ends, the content output apparatus 3 returns to the process in step S10.

In this way, the store operator can use, through the content output apparatus 3, the customer's smartphone, mobile phone terminal, tablet terminal, etc. as a loyalty card in the loyalty program.

When the customer passes the communication terminal 2 over the content output apparatus 3, the content output apparatus 3 distributes a coupon. This arouses the customer's willingness to purchase goods.

When the customer passes the communication terminal 2 over the content output apparatus 3, the content output apparatus 3 outputs video content by the content output unit 34 to create the virtual mannequin. The eye catching effect of the virtual mannequin can raise the interest of customers, who have not subscribed to the loyalty program, in the content output apparatus 3 and encourage them to subscribe to the loyalty program.

When the customer has passed the loyalty card over the content output apparatus 3 a predetermined number of times, the content output apparatus 3 outputs the video content corresponding to the number of communications by the content output unit 34 to create the virtual mannequin. Since the virtual mannequin is created by the video content corresponding to the number of times the customer has passed the loyalty card over the content output apparatus 3, the customer can be made to continuously feel interactivity with content. The customer's interest in the virtual mannequin and the loyalty program can therefore be maintained.

### Second Embodiment

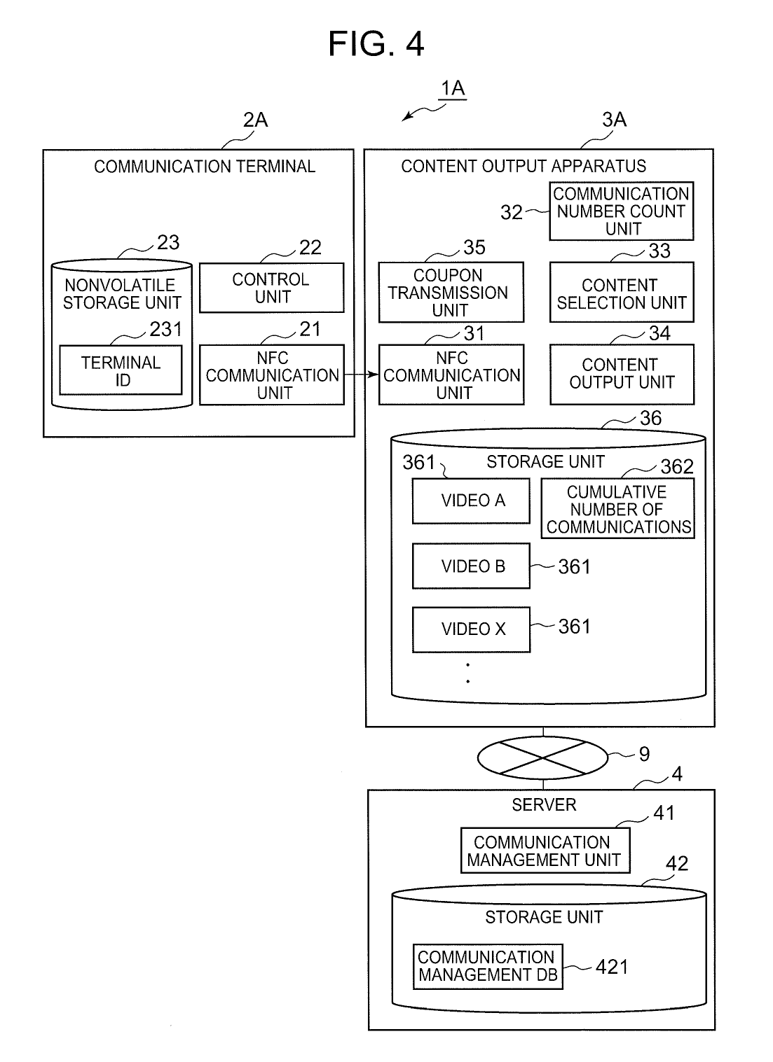

FIG. 4 is a block diagram schematically illustrating a content output system 1A in a second embodiment. The same elements as those in the content output system 1 in the first embodiment illustrated in FIG. 1 are given the same reference signs.

The content output system 1A in the second embodiment includes a communication terminal 2A and a content output apparatus 3A that differ from those in the first embodiment, and further includes a server 4 connected via a network 9.

Each communication terminal 2 in the first embodiment stores the information of the number of communications and the last communication date and time. On the other hand, the content output apparatus 3A in the second embodiment receives only the terminal ID from the communication terminal 2A, and transmits the information of the number of communications and the last communication date and time corresponding to the terminal ID to the server 4. This enables the loyalty program to be provided in smartphones, mobile phone terminals, tablet terminals, etc. without installing a special application.

Each communication terminal 2A in the second embodiment stores only the terminal ID information 231 in the nonvolatile storage unit 23, unlike in the first embodiment. The communication terminal 2A is not limited to an active tag capable of wireless communication without induced power, such as a smartphone, a mobile phone terminal, or a tablet terminal, but may be a passive tag that performs wireless communication with induced current. The passive tag is a smart card conforming to the NFC standard.

The content output apparatus 3A in the second embodiment does not store the coupon information 363 in the storage unit 36, unlike in the first embodiment. The other structures are the same as those of the content output apparatus 3 in the first embodiment.

The server 4 includes a communication management unit 41 and a storage unit 42. The storage unit 42 is, for example, a hard disk or flash memory, and stores a communication management database 421. The communication management unit 41 manages the communication management database 421.

The server 4 is connected to one or more content output apparatuses 3A via the network 9. Thus, the content output system 1A can collectively manage information of the loyalty program in a plurality of stores.

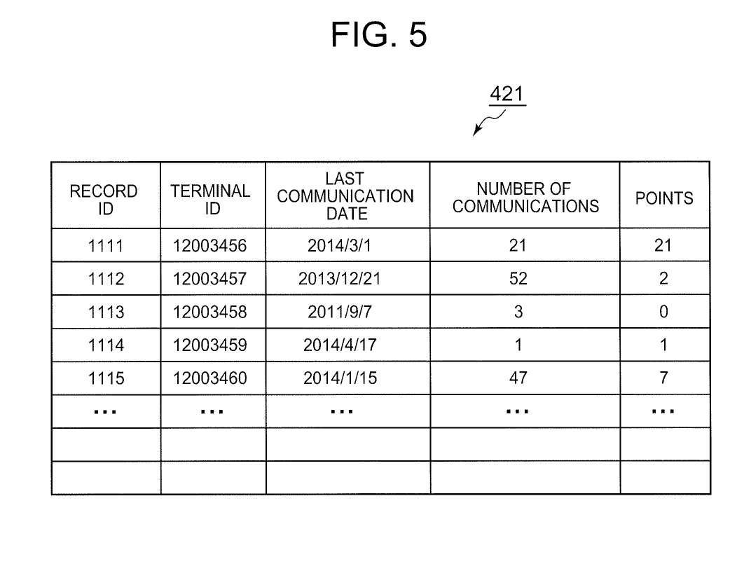

FIG. 5 is a diagram illustrating the communication management database 421 in the second embodiment.

The communication management database 421 has a record ID field, a terminal ID field, a last communication date field, a communication number field, and a point field.

The record ID field stores an identifier for identifying the corresponding record (entry).

The terminal ID field stores information of the terminal ID received from the communication terminal 2A.

The last communication date field stores the last date of communication with the communication terminal 2A.

The communication number field stores the number of communications with the communication terminal 2A.

The point field stores the number of points provided to the customer having the communication terminal 2A.

Since each set of information is managed in the communication management database 421 stored in the storage unit 42 of the server 4, unauthorized decoding and use of the information can be prevented.

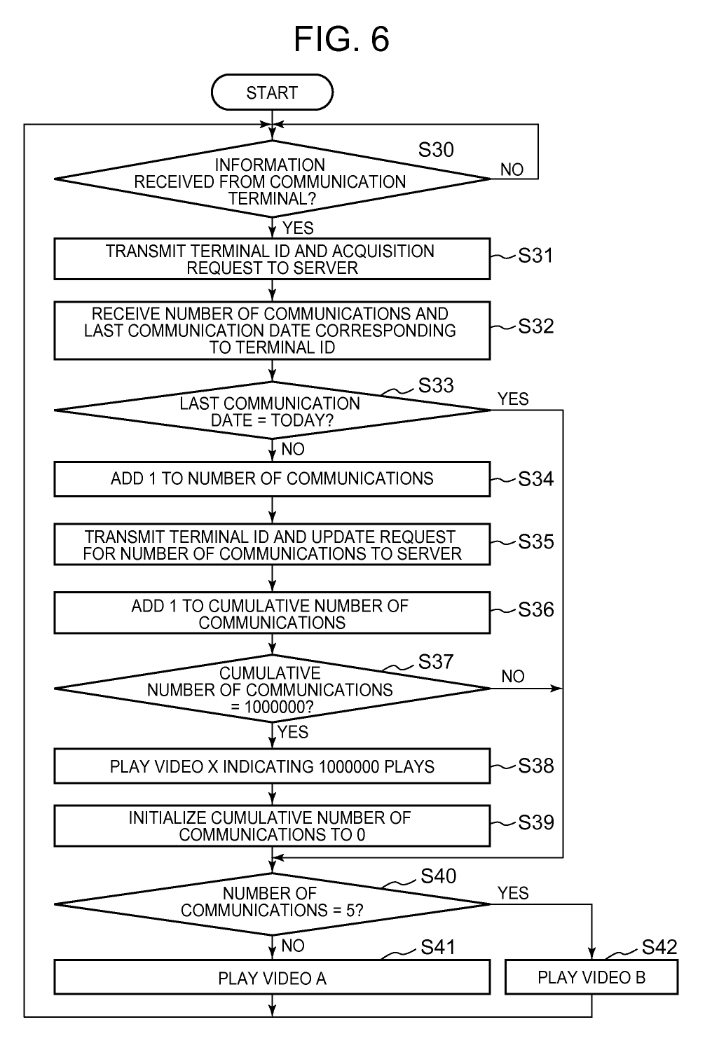

FIG. 6 is a flowchart illustrating the process by the content output apparatus 3A in the second embodiment.

When the content output apparatus 3A is activated, the content output apparatus 3A starts the process in FIG. 6.

In step S30, the NFC communication unit 31 in the content output apparatus 3A determines whether or not the terminal ID information 231 has been received from the communication terminal 2A. In the case where the terminal ID information 231 has not been received (No), the content output apparatus 3A repeats the process in step S30. In the case where the terminal ID information 231 has been received (Yes), the content output apparatus 3A performs the process in step S31.

In step S31, the content output apparatus 3A transmits a request to acquire information relating to the communication terminal 2A, to the server 4 via the network 9. The acquisition request includes the terminal ID information. The communication management unit 41 in the server 4 acquires the information relating to the communication terminal 2A from the communication management database 421, based on the terminal ID information.

In step S32, the content output apparatus 3A receives the information of the number of communications and the last communication date relating to the communication terminal 2A, from the server 4.

In step S33, the communication number count unit 32 in the content output apparatus 3A determines whether or not the last communication date of the communication terminal 2A is today. In the case where the last communication date is today (Yes), the content output apparatus 3A performs the process in step S40. In the case where the last communication date is not today (No), the content output apparatus 3A performs the process in step S34.

In step S34, the content output apparatus 3A adds 1 to the number of communications.

In step S35, the content output apparatus 3A transmits a request to update the number of communications, to the server 4. The request to update the number of communications includes the information of the number of communications and the terminal ID. The communication management unit 41 in the server 4 updates the information relating to the communication terminal 2A in the communication management database 421, based on the terminal ID information.

In step S36, the communication number count unit 32 in the content output apparatus 3A adds 1 to the cumulative number of communications.

In step S37, the content selection unit 33 in the content output apparatus 3A determines whether or not the cumulative number of communications has reached 1000000. In the case where the cumulative number of communications has reached 1000000 (Yes), the content output apparatus 3A performs the process in step S38. In the case where the cumulative number of communications has not reached 1000000 (No), the content output apparatus 3A performs the process in step S40.

In step S38, the content selection unit 33 in the content output apparatus 3A selects the video content X, and the content output unit 34 outputs and plays the video content X.

In step S39, the communication number count unit 32 in the content output apparatus 3A initializes the cumulative number of communications to 0.

In step S40, the content selection unit 33 in the content output apparatus 3A determines whether or not the number of communications with the communication terminal 2A is 5. In the case where the number of communications with the communication terminal 2A is 5 (Yes), the content output apparatus 3A performs the process in step S42. In the case where the number of communications with the communication terminal 2A is not 5 (No), the content output apparatus 3A performs the process in step S41.

In step S41, the content selection unit 33 in the content output apparatus 3A selects the video content A, and the content output unit 34 outputs the video content A. After the process in step S41 ends, the content output apparatus 3A returns to the process in step S30.

In step S42, the content selection unit 33 in the content output apparatus 3A selects the video content B, and the content output unit 34 outputs the video content B. After the process in step S42 ends, the content output apparatus 3A returns to the process in step S30.

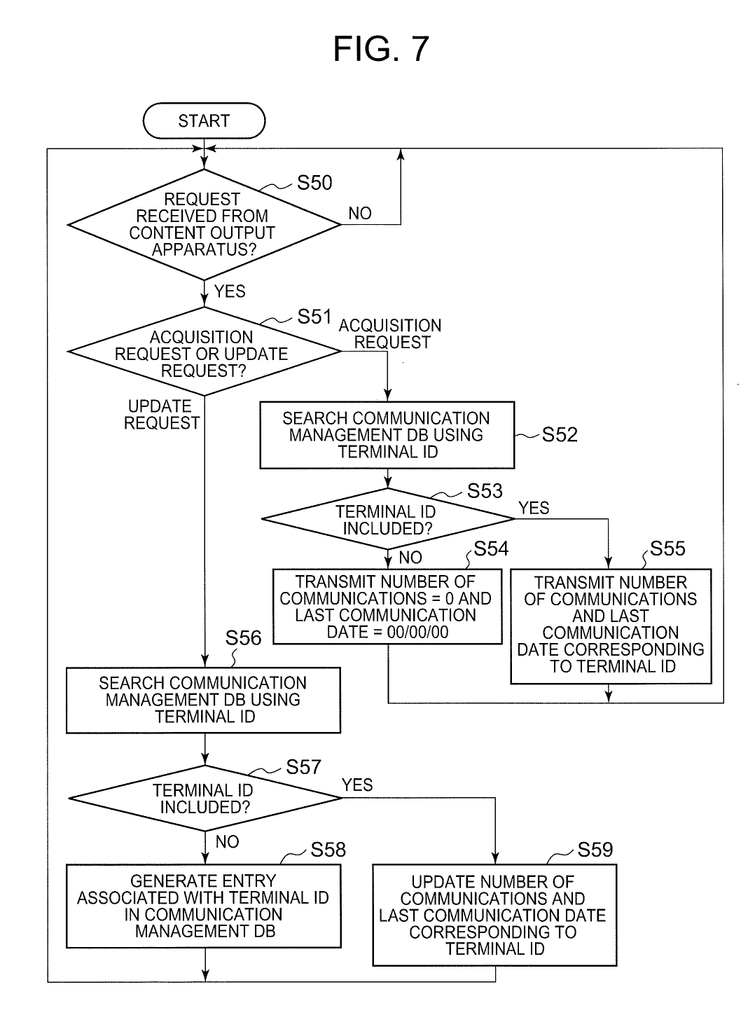

FIG. 7 is a flowchart illustrating the process by the server 4 in the second embodiment.

When the server 4 is activated, the server 4 starts the process in FIG. 7.

In step S50, the server 4 receives a request from the content output apparatus 3A via the network 9.

In step S51, the server 4 determines whether the received request is the acquisition request or the update request. In the case where the received request is the acquisition request, the server 4 performs the process in step S52. In the case where the received request is the update request, the server 4 performs the process in step S56.

In step S52, the communication management unit 41 in the server 4 searches the communication management database 421 using the terminal ID.

In step S53, the server 4 determines whether or not the record corresponding to the terminal ID is included in the communication management database 421. In the case where the record corresponding to the terminal ID is included (Yes), the server 4 performs the process in step S55. In the case where the record corresponding to the terminal ID is not included (No), the server 4 performs the process in step S54.

In step S54, the server 4 transmits the number of communications as 0 and the last communication date as 00/00/00 to the content output apparatus 3A, and returns to the process in step S50.

In step S55, the server 4 transmits the number of communications and the last communication date corresponding to the terminal ID to the content output apparatus 3A, and returns to the process in step S50.

In step S56, the server 4 searches the communication management database 421 using the terminal ID.

In step S57, the server 4 determines whether or not the record corresponding to the terminal ID is included in the communication management database 421. In the case where the record corresponding to the terminal ID is included (Yes), the server 4 performs the process in step S59. In the case where the record corresponding to the terminal ID is not included (No), the server 4 performs the process in step S58.

In step S58, the server 4 generates a new entry associated with the terminal ID in the communication management database 421, and returns to the process in step S50.

In step S59, the server 4 updates the number of communications and the last communication date in the communication management database 421 based on the terminal ID, and returns to the process in step S50.

In this way, the store operator can use, through the content output apparatus 3A and the server 4, not only the customer's smartphone, mobile phone terminal, or tablet terminal but also smart card, etc. as a loyalty card in the loyalty program. The store operator can also collectively manage the information of the loyalty program in the server 4.

The customer can use his or her smartphone, mobile phone terminal, or tablet terminal as a loyalty card in the loyalty program of the store, without installing the special application in the smartphone, mobile phone terminal, or tablet terminal.

### Third Embodiment

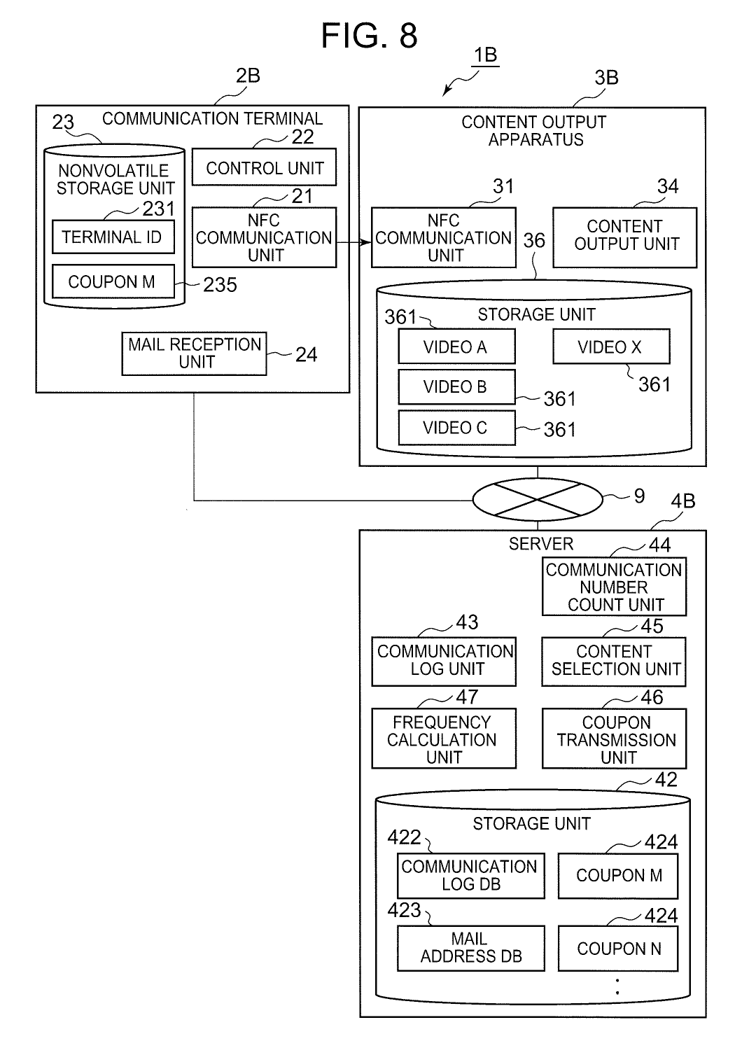

FIG. 8 is a block diagram schematically illustrating a content output system 1B in a third embodiment. The same elements as those in the content output system 1A in the second embodiment illustrated in FIG. 4 are given the same reference signs.

The content output system 1B in the third embodiment includes a communication terminal 2B, a content output apparatus 3B, and a server 4B that differ from those in the second embodiment.

Each communication terminal 2B in the third embodiment stores the coupon information 235 in the nonvolatile storage unit 23, and also includes a mail reception unit 24, unlike in the second embodiment.

The mail reception unit 24 receives email via the network 9. This enables the communication terminal 2B to electronically receive coupons.

The content output apparatus 3B in the third embodiment includes the NFC communication unit 31, the content output unit 34, and the storage unit 36, unlike in the second embodiment. The storage unit 36 stores video content C in addition to the video content A, B, and X. The video content C is content for customers who visit the store frequently.

The server 4B in the third embodiment includes the storage unit 42, a communication log unit 43, a communication number count unit 44, a content selection unit 45, a coupon transmission unit 46, and a frequency calculation unit 47. The storage unit 42 stores a mail address database 423 and each set of coupon information 424, in addition to the information in the second embodiment.

The communication log unit 43 records each log of communication performed between the communication terminal 2B and the content output apparatus 3B, in a communication log database 422.

The communication number count unit 44 counts the number of communications and the cumulative number of communications of each communication terminal 2B, based on the communication log database 422.

The content selection unit 45 selects video content corresponding to the number of communications or the cumulative number of communications.

The coupon transmission unit 46 (customer distribution information transmission unit) transmits the coupon information 424 to the communication terminal 2B, as a file attached to email. Thus, the content output system 1B can distribute coupons to customers, without using NFC communication.

The frequency calculation unit 47 calculates the most recent communication frequency of each communication terminal 2B, based on the communication log database 422. This enables the provision of a differentiated service to customers who visit the store frequently.

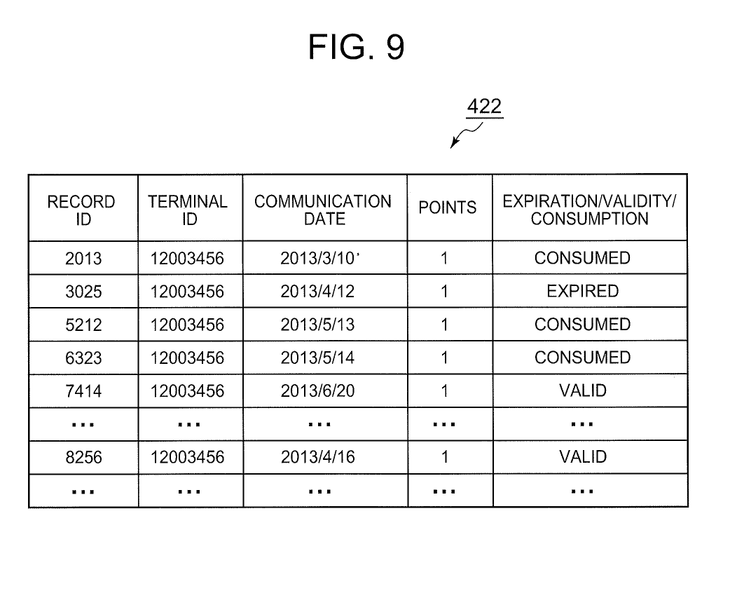

FIG. 9 is a diagram illustrating the communication log database 422 in the third embodiment. The communication log database 422 has a record ID field, a terminal ID field, a communication date field, a point field, and an expiration/validity/consumption field.

The record ID field stores an identifier for identifying the corresponding record (entry). When the communication terminal 2B and the content output apparatus 3B communicate with each other on a daily basis, a new record relating to the communication is recorded in the communication log database 422.

The terminal ID field stores information of the terminal ID received from the communication terminal 2B.

The communication date field stores the date of communication between the communication terminal 2B and the content output apparatus 3B.

The point field stores the points provided to the communication terminal 2B.

The expiration/validity/consumption field stores information of whether the points have expired, are valid, or have been consumed. In the loyalty program in the third embodiment, points offered to customers are valid for one year, i.e. expire after one year. The point expiration process is carried out by, for example, the server 4B performing batch processing at midnight or the like after the store's business hours and, from among all records in the communication log database 422, changing valid points of one year or more to expired points.

With this structure of the communication log database 422, in addition to managing the validity/consumption of points, the expiration of points a predetermined period after the provision can be made.

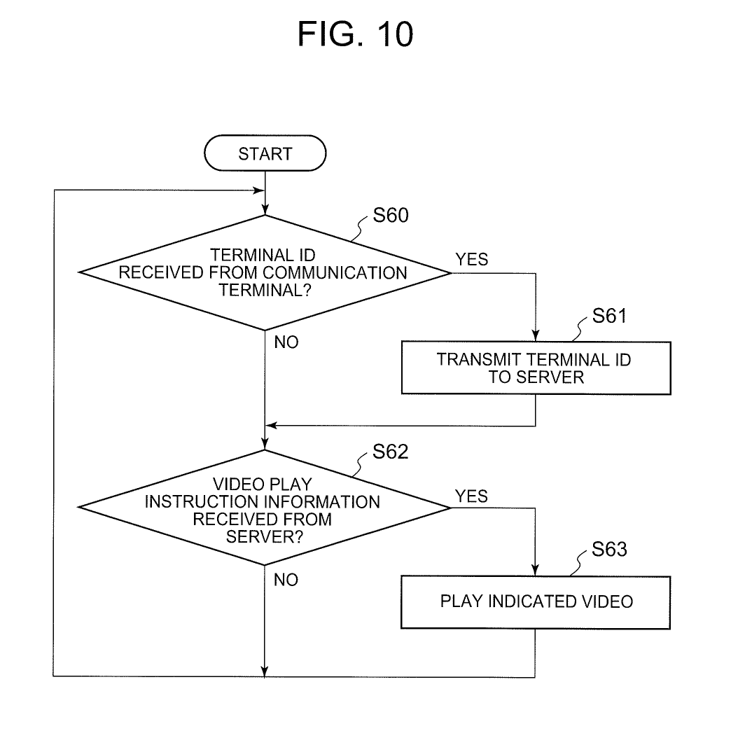

FIG. 10 is a flowchart illustrating the process by the content output apparatus 3B in the third embodiment.

When the content output apparatus 3B is activated, the content output apparatus 3B starts the process in FIG. 10.

In step S60, the NFC communication unit 31 in the content output apparatus 3B determines whether or not the terminal ID information 231 has been received from the communication terminal 2B. In the case where the terminal ID information 231 has not been received (No), the content output apparatus 3B performs the process in step S62. In the case where the terminal ID information 231 has been received (Yes), the content output apparatus 3B performs the process in step S61.

In step S61, the content output apparatus 3B transmits the terminal ID information to the server 4B.

In step S62, the content output apparatus 3B determines whether or not a video play instruction has been received from the server 4B. The video play instruction includes information indicating video content to be played. In the case where the video play instruction has been received from the server 4B (Yes), the content output apparatus 3B performs the process in step S63. In the case where the video play instruction has not been received from the server 4B (No), the content output apparatus 3B returns to the process in step S60.

In step S63, the content output apparatus 3B outputs and plays the indicated video content by the content output unit 34, based on the video play instruction. After the process in step S63 ends, the content output apparatus 3B returns to the process in step S60. This simplifies the process by the content output apparatus 3B, and reduces the number of man-hours for implementation and maintenance.

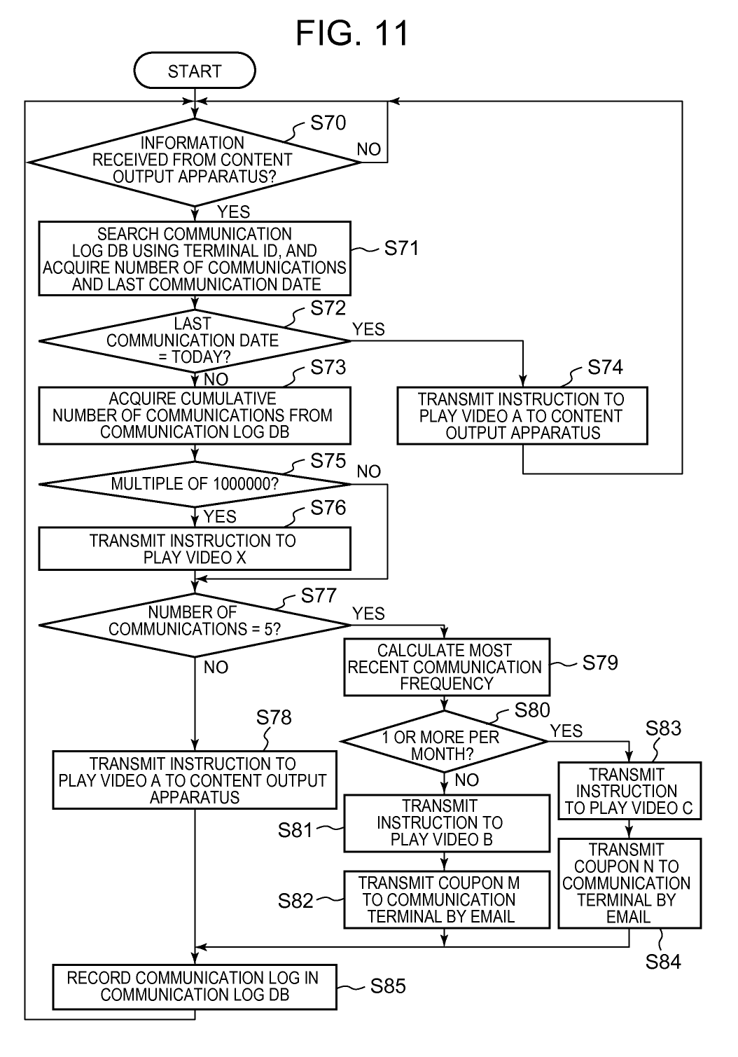

FIG. 11 is a flowchart illustrating the process by the server 4B in the third embodiment.

When the server 4B is activated, the server 4B starts the process in FIG. 11.

In step S70, the server 4B receives the terminal ID information from the content output apparatus 3B via the network 9.

In step S71, the server 4B searches the communication log database 422 using the terminal ID, and acquires the number of communications and the last communication date relating to the communication terminal 2B.

In step S72, the communication number count unit 44 in the server 4B determines whether or not the last communication date of the communication terminal 2B is today. In the case where the last communication date is today (Yes), the server 4B performs the process in step S73. In the case where the last communication date is not today (No), the server 4B performs the process in step S74.

In step S73, the server 4B transmits an instruction to play the video content A, to the content output apparatus 3B.

In step S74, the communication log unit 43 in the server 4B acquires the cumulative number of communications from the communication log database 422. The communication log unit 43 counts the total number of records in the communication log database 422, to acquire the cumulative number of communications.

In step S75, the server 4B determines whether or not the cumulative number of communications is a multiple of 1000000. In the case where the cumulative number of communications is a multiple of U.S. Pat. No. 1,000,000 (Yes), the server 4B performs the process in step S76. In the case where the cumulative number of communications is not a multiple of 1000000 (No), the server 4B performs the process in step S77.

In step S76, the server 4B transmits an instruction to play the video content X, to every content output apparatus 3B. The video content X is content indicating 1000000 plays.

In step S77, the content selection unit 45 in the server 4B determines whether or not the number of communications with the communication terminal 2B is 5. In the case where the number of communications with the communication terminal 2B is 5 (Yes), the server 4B performs the process in step S79. In the case where the number of communications with the communication terminal 2B is not 5 (No), the server 4B performs the process in step S78.

In step S78, the content selection unit 45 in the server 4B transmits an instruction to play the video content A, to the content output apparatus 3B.

In step S79, the frequency calculation unit 47 in the server 4B calculates the most recent communication frequency of the communication terminal 2B. The most recent communication frequency is the frequency of a predetermined number of most recent communications. In the third embodiment, the frequency calculation unit 47 calculates the number of days from the date of the third immediately preceding communication to today and divides the number of days by 3, to calculate the most recent communication frequency. Note that the most recent communication frequency is not limited to this, but may be the communication frequency in a most recent predetermined period.

In step S80, the content selection unit 45 in the server 4B determines whether or not the most recent communication frequency is 1 or more per month. In the case where the most recent communication frequency is 1 or more per month (Yes), the server 4B performs the process in step S83. In the case where the most recent communication frequency is not 1 or more per month (No), the server 4B performs the process in step S81.

In step S81, the server 4B transmits an instruction to play the video content B, to the content output apparatus 3B.

In step S82, the server 4B transmits the coupon M to the communication terminal 2B by email. The mail address of the communication terminal 2B is registered beforehand in the mail address database 423 in association with the terminal ID information. This is, however, not a limitation, and the mail address of another communication terminal different from the communication terminal 2B may be registered. This enables the use of a passive tag such as a smart card, with the communication terminal 2B.

In step S83, the server 4B transmits an instruction to play the video content C, to the content output apparatus 3B.

In step S84, the server 4B transmits the coupon N to the communication terminal 2B by email.

In step S85, the server 4B records the log of this communication in the communication log database 422, and returns to the process in step S70.

The content output system 1B in the third embodiment selects and outputs the content corresponding to the most recent frequency of communication between the communication terminal 2B and the content output apparatus 3B, and further selects and transmits the corresponding coupon. This motivates the customer having the communication terminal 2B to visit the store frequently, thus producing a greater customer attraction effect.

The content output system 1B in the third embodiment records the logs of all communications in the communication log database 422, and also manages the points offered to the customers in association with the communications. This eases the management of validity/consumption/expiration of points. Moreover, the cumulative number of communications by customers who have visited any of a plurality of stores can be counted easily. Such a system is suitable for use by chain store operators.

### Modifications

The present invention is not limited to the embodiments described above, but may be modified without departing from the scope of the present invention. For example, the following (a) to (d) are possible.

(a) The server 4B in the third embodiment may store new video content in the storage unit 42 and, before transmitting an instruction to play the new video content, distribute the new video content to each content output apparatus 3B. The video content to be output by the content output apparatus 3B can be easily replaced in this way.

(b) The content selection unit 33 in the first and second embodiments or the content selection unit 45 in the third embodiment may select video content with reference to a correspondence table of the number of communications and video content. With this structure, the content output system can easily customize video content play conditions.

(c) The communication between the communication terminal and the content output apparatus in the present invention is not limited to NFC. Any standard capable of wireless communication, such as Bluetooth®, Wi-Fi®, the radio frequency identifier (RFID), or the Infrared Data Association (IrDA), may be used.

(d) The content output unit in the present invention is not limited to a human-shaped life-sized virtual mannequin, but may be, for example, a desktop-sized small virtual mannequin or a display.

Although some embodiments of the present invention have been described above, the present invention is not limited to these but includes the invention defined in the claims and its equivalent scope.

What is claimed is:

1. A content output apparatus comprising:
a communication unit configured to wirelessly communicate with a communication terminal carried by a customer;
a control unit configured to count the number of communications with the communication terminal on a predetermined period basis, and select content corresponding to the number of communications; and
a content output unit configured to output the content selected by the control unit.

2. The content output apparatus according to claim 1, wherein the control unit is configured to count the number of communications on the predetermined period basis, by comparing a date and time of communication by the communication unit and a last communication date and time.

3. The content output apparatus according to claim 1, wherein the communication unit is configured to transmit customer distribution information corresponding to the content selected by the control unit, to the communication terminal.

4. The content output apparatus according to claim 1, wherein the control unit is configured to count a cumulative number of communications from the numbers of communications with communication terminals on the predetermined period basis, and select content corresponding to the counted cumulative number of communications.

5. A communication terminal that wirelessly communicates with the content output apparatus according to claim 1, the communication terminal comprising:
a communication unit configured to transmit and receive information of the number of communications and a last communication date to and from the content output apparatus; and
a nonvolatile storage unit configured to store the information of the number of communications and the last communication date received by the communication unit.

6. A content output method executed by a content output apparatus that includes: a communication unit configured to wirelessly communicate with a communication terminal; and a content output unit configured to output content, the content output method comprising:
counting the number of communications with the communication terminal on a predetermined period basis;
selecting content corresponding to the counted number of communications; and
outputting the selected content by the content output unit.

7. A computer-readable medium storing a program for causing a computer to execute:
a communication process of wirelessly communicating with a communication terminal;
a count process of counting the number of communications with the communication terminal on a predetermined period basis;
a content selection process of selecting content corresponding to the counted number of communications; and
a content output process of outputting the selected content by a content output unit.
